(19) United States
(12) Patent Application Publication
(10) Pub. No.: US 2026/0329491 A1
(43) Pub. Date: Oct. 22, 2026

(54) RECORDING MEDIUM, INFORMATION PROCESSING DEVICE, AND METHOD FOR CONTROLLING INFORMATION PROCESSING DEVICE

(71) Applicant: CANON KABUSHIKI KAISHA, Tokyo (JP)

(72) Inventor: YUTA WATANABE, Kanagawa (JP)

(21) Appl. No.: 19/632,772

(22) Filed: Mar. 30, 2026

(30) Foreign Application Priority Data
Apr. 22, 2025 (JP) 2025-070288

(51) Int. Cl. G06F 3/12

(52) U.S. Cl. CPC G06F 3/1229; G06F 3/1203

(57) ABSTRACT

Disclosed is a non-transitory storage medium storing instructions that, when executed by a processor of an information processing device managing network devices, cause the processor to: display a screen for setting notification of information related to a network device by the network device; and set notification on the basis of settings on the screen, wherein the screen displays information related to notification settings set in the network device, acquired from the network device.

### BACKGROUND

### Field of the Invention

The present disclosure relates to recording medium executed in an information processing device, an information processing device, and a method for controlling an information processing device.

### Description of the Related Art

In recent years, it has become possible for a management device to acquire various types of status information, such as an operational status and that of consumables, from remotely connected image forming devices (hereinafter referred to as devices), such as printers and multifunction peripherals. Furthermore, if a status acquired from a device matches notification conditions in notification settings stored in the management device, the management device can notify an administrator via email or the like. Meanwhile, the device can notify the administrator based on a status and notification settings stored in the device. The notification settings stored in the management device and the device may be used together in cases where there are administrators both in remote and nearby locations for the device, or where there are notification conditions that can only be determined by the management device or the device. Japanese Patent Laid-Open No. 2020-198002 discloses a method in which a management server acquires the status of a device, determines an error based on the status, and, if an error is determined to have occurred, transmits a message to a destination associated with the device.

However, although the management device notifies the destination associated with the device of an error in the method disclosed in Japanese Patent Laid-Open No. 2020-198002, the method does not fully consider cases where the device itself has error notification settings. Therefore, when an administrator sets notification for the management device, there is no easy setting method provided for unifying or separating destinations for the device. When an administrator sets notification for a device in an information processing device, it is required to be able to easily check the notification settings set in the device.

### SUMMARY

The present disclosure reduces the burden on an administrator who performs notification settings.

The present disclosure provides a non-transitory storage medium storing instructions that, when executed by a processor of an information processing device that manages network devices, cause the processor to: display a screen for setting notification of information related to a network device by the network device; and set a notification setting on the basis of settings on the screen, wherein the screen displays information related to a notification setting set in the network device, acquired from the network device.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a system configuration.

FIG. 2 is a diagram illustrating a hardware configuration.

FIG. 3 is a diagram illustrating a software configuration of a management device.

FIG. 4 is a diagram illustrating a software configuration of a printing device.

FIG. 5 is a diagram illustrating an example of a device management screen of the management device.

FIG. 6 is a diagram illustrating an example of a notification setting creation screen of the management device.

FIG. 7 is a diagram illustrating an example of a device/group selection screen of the management device.

FIG. 8 is a diagram illustrating an example of a destination setting checking screen of the management device.

FIG. 9 is a diagram illustrating an example of a basic notification setting creation flow.

FIG. 10 is a diagram illustrating an example of a device/group selection flow.

FIG. 11 is a diagram illustrating an example of a destination setting checking flow.

FIG. 12 is a diagram illustrating an example of a notification setting creation screen of a management device in Embodiment 2.

FIG. 13 is a diagram illustrating an example of a notification setting creation screen of a management device in Embodiment 3.

FIG. 14 is a diagram illustrating an example of a text setting checking screen of the management device in Embodiment 3.

### DESCRIPTION OF THE EMBODIMENTS

### Embodiment 1

A device management system according to the present embodiment will be described. The system of the present embodiment is a system for managing network devices. As part of network device management, the system notifies information processing devices, such as terminals used by network device administrators and users, of information on network devices. Notification of information related to a network device can be sent from the network device itself or from an application that manages the network device and is installed in an information processing device. Notification settings for notification of information on a network device can be set in both the network device and an information processing device of an administrator. The present embodiment describes a case in which, in a state in which notification settings have already been set in a network device, notification settings are further set in an application installed in an information processing device of an administrator.

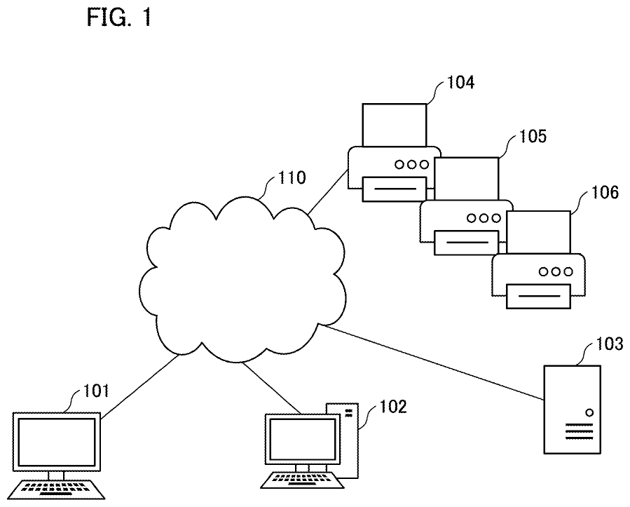

FIG. 1 is a block diagram illustrating a configuration of a system. The system includes printing devices (e.g., printing devices 104 to 106) that are network devices to be managed, a mail server 103 that transmits notifications, and information processing devices (e.g., a client 101 and a management device 102) that are notification destinations. These are connected to each other via a network 110 such that they can communicate with each other.

The client 101 is an information processing device serving as a client. The client 101 is, for example, a personal computer. The client 101 is used by, for example, a user who uses the printing devices 104 to 106. The management device 102 is an information processing device for managing network devices. The management device 102 is, for example, a personal computer. The management device 102 is used by an administrator who manages the printing devices 104 to 106. The management device 102 includes a communication device capable of bidirectional communication with other network devices connected to the network 110, monitors the status of the network devices, and performs various settings. Further, an application for managing network devices (hereinafter also referred to as a device management application) is installed in the management device 102 of the present embodiment. The device management application can monitor the status of network devices, such as the occurrence of alerts in network devices to be managed. The device management application can notify the user of information regarding network devices in response to alerts from the network devices to be managed. In the present embodiment, an example of a case in which an email is sent as a notification will be described. Note that notifications may be performed by methods other than email, such as SMS and push notification. In addition, the management device 102 can also set notification settings for sending such notifications. The management device 102 can also function as a client. The client 101 and the management device 102 can execute various programs such as application programs, and are equipped with a printer driver that has the function of converting print data into a printer language compatible with a printer. The printer driver supports, for example, a plurality of printers.

The mail server 103 is an information processing device serving as a mail server. For example, the mail server 103 sends emails notifying information regarding network devices in response to requests from the management device 102 or network devices (printing devices 104 to 106). The client 101, the management device 102, and the mail server 103 are connected to the network 110 via network cables such as Ethernet (registered trademark). Further, the client 101, the management device 102, and the mail server 103 are also equipped with communication devices capable of bidirectional communication with other apparatuses connected to the network 110. Control programs for realizing various controls are stored in an executable manner in storage media such as HDs and ROMs of the client 101, the management device 102, and the mail server 103. Note that, although the client 101, the management device 102, and the mail server 103 are described as separate information processing devices in the present embodiment, equivalent functions may be realized by a single information processing device. Furthermore, the mail server 103 may be realized by one or more information processing devices, a virtual machine (cloud service) that uses resources provided by a data center including information processing devices, or a combination thereof.

The printing device 104 is an example of a network device in the present embodiment. The printing devices 105 and 106 are also network devices with a similar configuration to the printing device 104. In the following, the printing devices, which are network devices, will be described mainly using the printing device 104 as an example. The printing device 104 in the present embodiment is a printer, a copier, a multifunction peripheral, or the like having a printing function. The printing device 104 receives print data (print jobs) via the network 110 using the printing function and performs printing on actual paper or the like using a known printing technique such as electrophotography or inkjet technology. For example, the printing device 104 executes printing processing in accordance with a print job received from the client 101. The printing method may be any of a variety of methods, such as a laser beam printer using electrophotography, an inkjet printer using an inkjet, or a printer using thermal transfer.

Furthermore, the printing device 104 in the present embodiment can perform notification settings for notifying an information processing device such as the management device 102 of information regarding the printing device 104. The printing device 104 executes notification processing for notifying information regarding the printing device 104 via the mail server 103 or the like in accordance with the notification settings set in the printing device 104. Further, the printing device 104 can share the status thereof, such as the occurrence of an alert, with the device management application of the management device 102 via the device management system. Although an example of a case in which network devices are printing devices is described in the present embodiment, the present disclosure is not limited thereto. The network devices may be any devices capable of communication, such as a scanner, a 3D printer, a laptop computer, a smartphone, or a smart home appliance.

The client 101, the management device 102, the mail server 103, and the printing devices 104 to 106 are connected to the network 110. The network 110 may be configured to be able to transmit and receive data, and any communication method is acceptable. For example, the network 110 may be configured as any one of or a combination of a LAN, a WAN, a cellular network such as LTE or 5G, a wireless network, a telephone line, a dedicated digital line, etc.

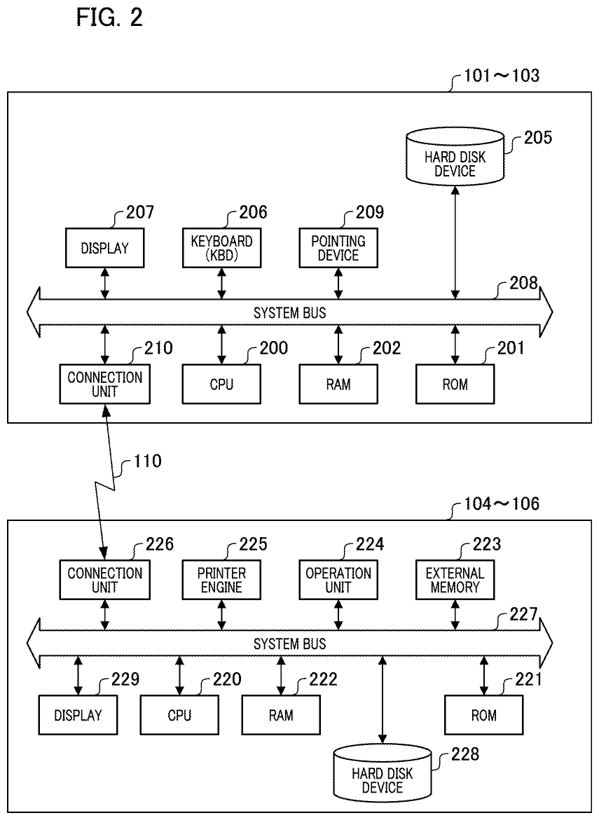

Next, hardware configurations of the information processing devices and printing devices will be described using FIG. 2. FIG. 2 is a diagram illustrating hardware configurations. First, the hardware configuration of the information processing devices, which are the client 101, management device 102, and mail server 103, will be described using the management device 102 as an example. The management device 102 includes a CPU 200, a ROM 203, a RAM 202, a hard disk device 205, a keyboard 206, a pointing device 209, a display 207, and a connection unit 210. These components are connected to each other via a system bus 208. The system bus 208 controls the flow of data within the information processing device.

The CPU (Central Processing Unit) 200 controls the entire management device 102. The ROM (Read Only Memory) 201 stores programs including a basic I/O program of the management device 102, and the like, and various types of data such as font data and template data used during document processing. The RAM (Random Access Memory) 202 is a temporary storage unit serving as a memory and work area of the CPU 200.

The hard disk device 205 is a large-capacity memory. The hard disk device 205 is, for example, an HDD (Hard Disk Drive), SSD (Solid State Drive), or the like. The hard disk device 205 stores programs such as application programs, printer driver programs, OS programs, control programs, and related programs, and various types of data. The programs stored in the hard disk device 205 also include a device management application program for managing network devices.

By executing programs stored in a memory (the ROM 201, the hard disk device 205, or the like), the CPU 200 comprehensively controls each component connected to the system bus 208 to control the management device 102. Furthermore, the CPU 200 controls temporary storage of information, files, etc. required for program execution in the RAM 202. The programs executed by the CPU 200 in the management device 102 include a program for setting notifications from network devices to be executed by the computer of the management device 102 that manages network devices.

The management device 102 may also include an external recording medium as a memory. Examples of external recording media include, but are not limited to, a CD-ROM, a CD-R, a CD-RW, a PC card, a DVD, a memory card, a MO, etc. Computer-readable programs and data are stored in the external recording medium. The management device 102 reads programs and data from the external recording medium via an interface such as an optical disc (CD) drive.

The keyboard 206 and the pointing device 209 are input units that receive instructions from the user. The keyboard 206 receives user input of device control commands and the like. The pointing device 209 receives user instructions. The display 207 is a display unit that displays commands input through the keyboard 206, a printer status, and the like. Note that the display 207 serving as a display device, and the keyboard 206 and the pointing device 209 serving as operation units may be integrated into a touch panel. By associating input coordinates with display coordinates on the touch panel, a graphical user interface (GUI) that allows the user to directly operate a screen displayed on the touch panel can be configured. The connection unit 210 transmits/receives data to/from external devices such as the printing device 104 and the mail server 103 via the network 110.

Next, the hardware configuration of the printing devices 104 to 106 will be described using the printing device 104 as an example. The printing device 104 has a connection unit 226, a printer engine 225, an operation unit 224, an external memory 223, a CPU 220, a RAM 222, a ROM 221, a hard disk device 228, and a display 229. These components are connected to each other via a system bus 227. The system bus 227 controls the flow of data within the printing device.

The CPU 220 controls the entire printing device 104. The RAM 222 is a main memory of the CPU 220. When the CPU 220 executes control, the RAM 222 is used as a work data area. Further, the RAM 222 functions as a temporary storage area for various types of data. The ROM 221 is an internal memory of the printer and stores various types of data, control programs for controlling the printing device 104, and the like. The ROM 221 stores, for example, font data, emulation programs, form data, and the like.

The hard disk device 228 is a large-capacity memory. The hard disk device 228 is, for example, a hard disk drive (HDD), a solid state drive (SSD), or the like. The hard disk device 228 stores various types of data and programs such as application programs, control programs, and related programs. The printing device 104 may also have the external memory 223 that stores various types of data and programs used by the printing device 104.

The CPU 220 executes a program stored in a memory (the ROM 221 or the hard disk device 228) to comprehensively control each component connected to the system bus 227 and control the printing device 104. When performing printing, the CPU 220 transmits image data to the printer engine 225 in accordance with printer control commands (transmission data) received through the connection unit 226 on the basis of a control programs stored in a memory (the ROM 221, etc.).

The printer engine 225 processes image data for printing and performs printing. The operation unit 224 receives user operation and displays results. The operation unit 224 has input units such as an operation panel and operation switches for receiving user operations. The operation unit 224 also has a display unit such as an LED or LCD panel for outputting display. The user can use the operation unit 224 to instruct settings for the printing device 104 and check the settings. The operation unit 224 may also be a touch panel in which an input unit and a display unit are integrated.

The connection unit 226 connects to and communicates with external devices such as the client 101, the management device 102, and the mail server 103 via the network 110. For example, the connection unit 226 receives print control commands (transmission data) from the client 101 via the network 110. The connection unit 226 also notifies the client 101 and the management device 102 of the status of the printing device 104 via the network 110 and the mail server 103. Note that software that realizes the same functions as the above components may be configured as an alternative to the hardware devices.

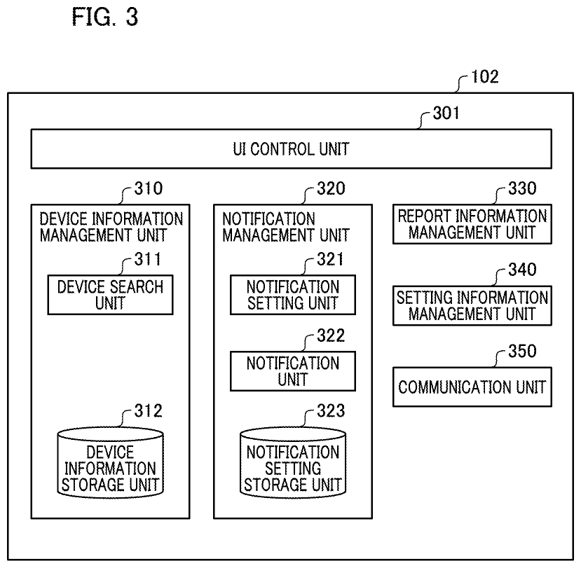

FIG. 3 is a diagram illustrating an example of the software configuration of the management device 102. The software configuration of the management device 102 illustrated in FIG. 3 is realized by the CPU 200 of the management device 102 reading and executing programs from the ROM 201. The management device 102 includes a UI control unit 301, a device information management unit 310, a notification management unit 320, a report information management unit 330, a setting information management unit 340, and a communication unit 350.

The UI control unit 301 is a display control unit that controls the UI of the management device 102. In the present embodiment, the UI control unit 301 controls the display of the UI for device management. Note that the UI control unit 301 can also be realized as a web-based application. When the UI control unit 301 is realized as a web-based application, the UI control unit can be used through a web browser.

The device information management unit 310 manages information about network devices managed by the management device 102. In the present embodiment, the device information management unit 310 manages information on the printing devices 104 to 106 connected to the network 110. The device information management unit 310 includes a device search unit 311 and a device information storage unit 312.

The device search unit 311 searches for network devices to be managed and acquires and manages device information from the searched network devices. The device search unit 311 has a device search function using, for example, SNMP (Simple Network Management Protocol), IP Broadcast, SLP/Multicast, etc. The device search unit 311 searches for network devices connected to the network 110 at any timing. In addition, the device search unit 311 has a function of acquiring/changing device information such as MIB (Management Information Base) from network devices via the network 110. As a result of device search, the device search unit 311 acquires device information on the searched network devices and saves the same in the device information storage unit 312. Device information includes, for example, a device name, installation location, status, etc. The device information storage unit 312 is a data recording medium such as a database, and saves device information on network devices. The device information storage unit 312 saves table data such as device tables and group tables for network devices to be managed.

Here, tables managed by the management device 102 will be described using Tables 1 and 2. Table 1 is a device table. Each record in the device table contains one device managed by the management device 102.

TABLE 1

| Device ID | Device name | Installation location | Status |
|---|---|---|---|
| DEV001 | Device 001 | Building A, first floor | No paper |
| DEV002 | Device 002 | Building A, second floor | Normal |
| ... | ... | ... | . . . |
| DEV101 | Device 101 | Building B, first floor | Normal |
| ... | ... | | |

The device table includes, for example, a device ID, device name, installation location, and status. The device ID is identification information for uniquely identifying a network device to be managed. The installation location indicates the installation location of the network device, and the status indicates the latest status of the network device.

Table 2 is a group table. In the group table, device groups managed by the management device 102 are recorded one per record. In the present embodiment, an example in which networks are grouped for each installation location is described, but the grouping criteria are not limited thereto.

TABLE 2

| Group ID | Group name | Device ID |
|---|---|---|
| GRP001 | Building A | DEV001, DEV002, ... |
| GRP002 | Building B | DEV101, DEV102, ... |
| ... | ... | |

The group table includes, for example, a group ID, group name, and device ID. The group ID is identification information for uniquely identifying a group. The device ID stores the device ID of a network device belonging to the group.

The notification management unit 320 manages notification information with respect to network devices managed by the management device 102. The notification management unit 320 realizes the notification function of the device management application included in the management device 102. The notification management unit 320 includes a notification setting unit 321, a notification unit 322, and a notification setting storage unit 323. The notification setting unit 321 receives notification settings with respect to network devices from an administrator and stores the same as notification settings in the notification setting storage unit 323. For example, the notification setting unit 321 receives a monitoring target, target status, destination, and text designated by the administrator via the UI control unit 301, and stores the same in the notification setting storage unit 323 as notification settings.

The notification unit 322 determines whether a notification is necessary on the basis of device information (e.g., status) stored in the device information storage unit 312 and the notification settings stored in the notification setting storage unit 323. The notification unit 322 then associates the device ID of a device determined to require notification with the notification settings and stores the same in the notification setting storage unit 323. Furthermore, the notification unit 322 executes notification in accordance with the notification setting for a device ID for which notification has changed from unnecessary to necessary. Whether notification is necessary is determined when device information is acquired, notification settings are created or changed, or a monitoring target is changed. The notification setting storage unit 323 stores information about notification settings.

Here, an example of a notification setting table is described. Table 3 is a notification setting table. In the notification setting table, one notification setting managed by the management device 102 is recorded per record.

TABLE 3

| Notification | Notification | | Monitoring | | | Notification | Enabled/ |
|---|---|---|---|---|---|---|---|
| setting ID | setting name | Status | target | Destination | Text | required | disabled |
| ALART001 | Paper jam in | Paper | GRP001 | maintainer@ ... | Paper | | Enabled |
| | building A | jam | | | jam is .. | | |
| ALART002 | No paper in | No | GRP001 | mfp-a@ ... | Paper is | DEV001 | Enabled |
| | building A | paper | | | ... | | |
| ALART101 | Paper jam in | Paper | GPR002 | maintainer@ ... | Paper | | Enabled |
| | building B | jam | | | jam is | | |
| | | | | | ... | | |
| ALART102 | No paper in | No | GPR002 | mfp-b@ ... | Paper is | | Enabled |
| | building B | paper | | | ... | | |
| ... | | ... | | | | | |

The notification setting table includes, for example, a notification setting ID, notification setting name, status, monitoring target, destination, text, notification required, and enabled/disabled. The notification setting ID is identification information for uniquely identifying notification setting. The status indicates the status of a network device that is a target of notification (e.g., an error state such as a paper jam). Note that, although an example in which each notification setting has one status as a condition here, the present disclosure is not limited thereto, and an OR or AND condition for a plurality of statuses may be held. The monitoring target indicates a network device for which notification is performed in the notification setting. For example, a group ID is set as the monitoring target. Note that, although an example in which one group ID is set as information identifying a device that is a monitoring target of notification setting is illustrated here, the present disclosure is not limited thereto, and one or more device IDs or a plurality of group IDs may be held as monitoring targets. The destination is the email address to which the notification is sent. The text is the contents to be displayed in the notification. The notification required field holds a list of device IDs of devices for which the notification unit 322 has determined that notification is required as a result of determining whether notification is required. The enabled/disabled indicates whether the notification setting is currently enabled or disabled.

The report information management unit 330 manages report information managed by the management device 102. The setting information management unit 340 manages setting information managed by the management device 102. The communication unit 350 transmits/receives data to/from external devices such as the mail server 103 and the printing devices 104 to 106 via the network 110.

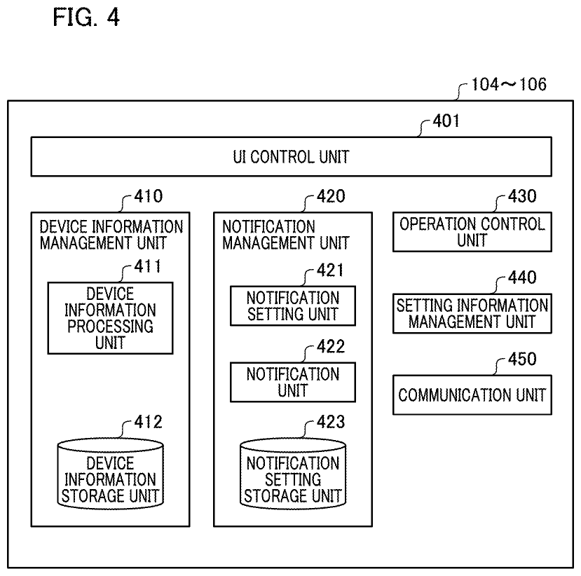

FIG. 4 is a diagram illustrating an example of the software configuration of the printing devices 104 to 106. Here, the software configuration of the printing device 104 will be described as an example. The software configuration of the printing device 104 illustrated in FIG. 4 is realized when the CPU 220 of the printing device 104 reads and executes a program from the ROM 221. The printing device 104 has a UI control unit 401, a device information management unit 410, a notification management unit 420, an operation control unit 430, a setting information management unit 440, and a communication unit 450.

The UI control unit 401 controls the UI of the printing device 104. The device information management unit 410 manages device information of the printing device 104. Therefore, the device information management unit 410 of the printing device 104 manages the device information of the printing device 104. Device information includes the device name, installation location, status, etc.

The device information management unit 410 has a device information processing unit 411 and a device information storage unit 412. The device information processing unit 411 receives instructions from the UI control unit 401 or the communication unit 450, and acquires/updates device information stored in the device information storage unit 412. The device information processing unit 411 also detects changes in the status of the printing device 104 and updates the status of the device information stored in the device information storage unit 412. The device information storage unit 412 stores device information.

The notification management unit 420 manages notification settings for information regarding the printing device 104, which are set in the printing device 104. The notification management unit 420 has a notification setting unit 421, a notification unit 422, and a notification setting storage unit 423. The notification setting unit 421 receives and sets designation related to notification from the administrator via the UI control unit 401. Specifically, the notification setting unit 421 receives, from the administrator via the UI control unit 401, designation of the status of a printing device that is a target of notification, notification destination, and text of notification, and stores the same as notification settings in the notification setting storage unit 423. The notification setting unit 421 also receives an instruction to acquire notification settings from the communication unit 450, acquires the notification settings from the notification setting storage unit 423, and returns the same to the communication unit 450.

The notification unit 422 determines whether a notification is necessary on the basis of the device information stored in the device information storage unit 412 and the notification settings stored in the notification setting storage unit 423, and stores the determination of whether a notification is necessary in association with the notification settings in the notification setting storage unit 423. Furthermore, the notification unit 422 executes notification for notification settings that have changed from unnecessary to necessary. Whether a notification is necessary is determined when a status change occurs or a notification setting is created or changed. The notification setting storage unit 423 stores notification settings. For example, the notification setting storage unit 423 stores information about notification settings, such as a target status, destination, text, and whether a notification is necessary, as a notification setting table.

The operation control unit 430 receives instructions from the UI control unit 401 or the communication unit 450 and executes printing, etc. The setting information management unit 440 manages setting information for each device. The communication unit 450 transmits/receives data to/from external devices such as the client 101, the management device 102, and the mail server 103 via the network 110. For example, the communication unit 450 receives a request from the management device 102 to acquire notification settings set in the printing device 104, acquires the notification settings set in the printing device 104 from the notification management unit 420, and transmits the notification settings set in the printing device 104 to the management device 102.

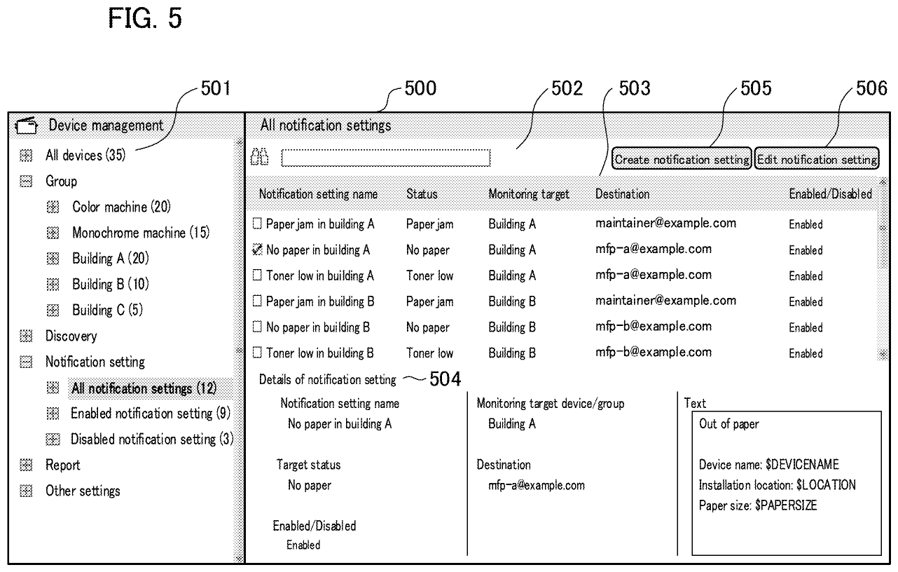

Next, UIs displayed on the display 207 by the management device 102 will be described using FIG. 5 to FIG. 8. FIG. 5 illustrates an example of a UI of a device management screen 500. The device management screen 500 is displayed on the display 207 of the management device 102 by the UI control unit 301. The device management screen 500 includes a device management menu 501 and a function display area 502 in which display contents change depending on a menu item selected by the administrator from the device management menu.

The device management menu 501 displays menus for the functions of the management device 102. For example, the device management menu 501 displays menu groups such as “All Devices,” “Group,” “Discovery,” “Notification Settings,” “Report,” and “Other Settings” in a tree format. Furthermore, when a menu group is selected, menus belonging to the selected menu group may be displayed in the device management menu 501. For example, when “Group” which indicates a group of devices to be managed is selected, group names such as “Building A” and “Building B” are displayed in the device management menu 501. Additionally, when “Notification Settings” is selected, “All Notification Settings,” “Enabled Notification Settings,” “Disabled Notification Settings,” etc. are displayed in the device management menu 501.

The display in the function display area 502 changes depending on selection of a menu displayed in the device management menu 501. FIG. 5 illustrates an example in which “All Notification Settings” under “Notification Settings” is selected in the device management menu 501, and “All Notification Settings” is displayed in the function display area 502. The “All Notification Settings” screen displayed in the function display area 502 displays, for example, a notification setting list 503, detailed settings 504, a notification creation button 505, and a notification editing button 506.

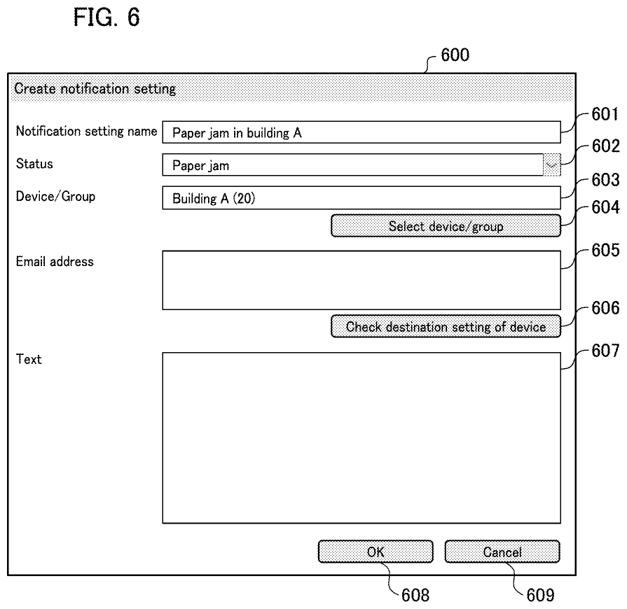

When the administrator selects a notification setting from the device management menu 501 on the device management screen 500, the notification setting list 503 displays the corresponding notification setting along with associated information. The detailed settings 504 display detailed information about the notification setting selected by the administrator in the notification setting list 503. The detailed information about the notification setting displayed in the detailed settings 504 includes, for example, the notification setting name, target status, whether notification is enabled or disabled, device or device group which is a target of notification setting, and notification destination. The notification creation button 505 is a button for allowing the administrator to create a notification setting. Upon detecting that the notification creation button 505 has been pressed, the UI control unit 301 displays a notification setting creation screen 600 illustrated in FIG. 6. The notification editing button 506 is a button for allowing the administrator to edit a selected notification setting.

FIG. 6 to FIG. 8 illustrate examples of screens for setting notifications of information related to a network device by the network device. FIG. 6 illustrates an example of a UI of a notification setting creation screen in Embodiment 1. The notification setting creation screen 600 is displayed on the display 207 of the management device 102 by the UI control unit 301. The notification setting creation screen 600 is displayed by pressing the notification creation button 505, which is displayed when the notification setting menu is selected on the device management screen 500. The notification setting creation screen 600 is a screen for setting a notification of information related to a network device to be managed from the network device.

The notification setting creation screen 600 includes, for example, a notification setting name input area 601, a target status selection area 602, a device display area 603, a device selection button 604, a destination input area 605, and a text input area 607. The notification setting creation screen 600 also includes an OK button 608 and a cancel button 609. Further, the notification setting creation screen 600 displays a button for acquiring and displaying information related to notification settings set in a network device from the network device. In the present embodiment, the notification setting creation screen 600 displays a destination setting checking button 606 as a button for acquiring and displaying information related to notification settings set in the network device from the network device.

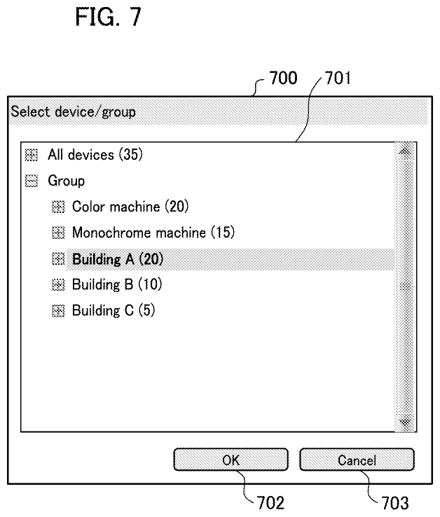

An arbitrary notification setting name is input to the notification setting name input area 601. In the target status selection area 602, a target status that will be a notification condition is selected from a list. In the device display area 603, a device that is a notification targets for notification setting being set is displayed. Further, a plurality of devices may be selected and displayed at once by selecting a device group. A notification target is selected on a device/group selection screen 700 illustrated in FIG. 7, and a result of selection on the device/group selection screen 700 is displayed in the device display area 603. The device selection button 604 is a button for displaying the device/group selection screen 700, which is a screen for selecting a notification target. Upon detecting that the device selection button 604 has been pressed, the UI control unit 301 displays the device/group selection screen 700.

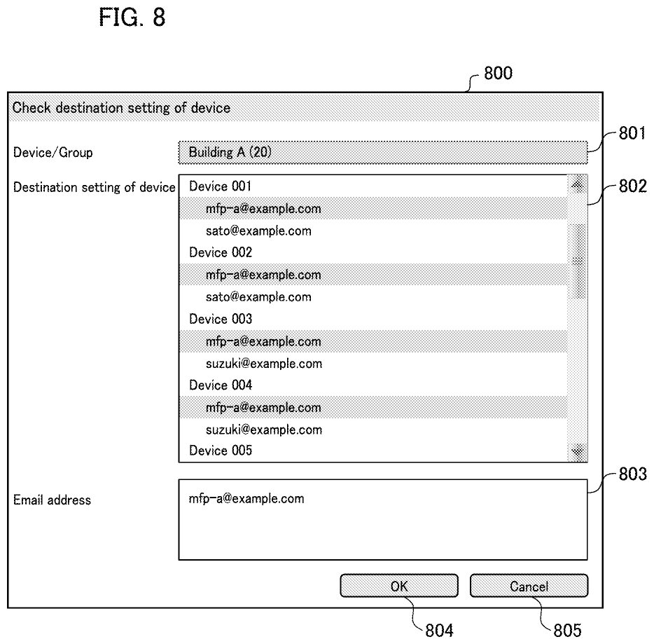

The destination of a notification is input to the destination input area 605. The destination of a notification can be set by directly inputting the destination or by selecting the destination on a destination setting checking screen 800 illustrated in FIG. 8. Any email address can be input to the destination input area 605 as a destination of a notification. The destination input area 605 also displays results of input on the destination setting checking screen 800 illustrated in FIG. 8. The destination setting checking button 606 is a button for displaying the destination setting checking screen 800. Upon detecting that the destination setting checking button 606 has been pressed, the UI control unit 301 displays the destination setting checking screen 800. The destination setting checking button 606 is enabled only when a device or a group is selected.

Notification text (email text) can be input to the text input area 607. The OK button 608 is a button for creating notification settings set by the administrator on the notification setting creation screen 600. Upon detecting that the OK button 608 has been pressed, the notification setting unit 321 creates notification settings based on the contents set on the notification setting creation screen 600, and the UI control unit 301 closes the notification setting creation screen 600. The OK button 608 is enabled only when the notification setting name input area 601, target status selection area 602, device display area 603, destination input area 605, and text input area 607 have been filled in. The cancel button 609 is a button for discarding the creation of a notification setting. Upon detecting that the cancel button 609 has been pressed, the UI control unit 301 discards the input contents on the notification setting creation screen 600 and closes the notification setting creation screen 600.

FIG. 7 illustrates an example of a UI for the device/group selection screen 700. The device/group selection screen 700 is displayed on the display 207 of the management device 102 by the UI control unit 301. The device/group selection screen 700 is displayed when the administrator presses the device selection button 604 on the notification setting creation screen 600 illustrated in FIG. 6. The device/group selection screen 700 includes a device/group selection area 701, an OK button 702, and a cancel button 703.

The device/group selection area 701 displays devices and groups managed by the management device 102 in a tree that can be open/closed. By pressing each line displayed in the device/group selection area 701, the device or group corresponding thereto can be selected. The selected device or group is displayed in a highlighted manner according to highlight display. Upon selection of the device or group in the device/group selection area 701, the administrator presses the OK button 702. Note that the OK button 702 is only enabled if a device/group has been selected in the device/group selection area 701.

Upon detecting that the OK button 702 has been pressed, the notification setting unit 321 reflects the selection status in the device/group selection area 701 in the device display area 603 of the notification setting creation screen 600 (FIG. 6). In addition, the UI control unit 301 closes the device/group selection screen 700 and transitions to the notification setting creation screen 600. Upon detecting that the cancel button 703 has been pressed, the notification setting unit 321 discards the selection status in the device/group selection area 701. In addition, the UI control unit 301 closes the device/group selection screen 700 and transitions to the notification setting creation screen 600.

FIG. 8 illustrates an example of a UI for the destination setting checking screen 800. The destination setting checking screen 800 is displayed on the display 207 of the management device 102 by the UI control unit 301. The destination setting checking screen 800 is displayed when the administrator presses the destination setting checking button 606 on the notification setting creation screen 600 illustrated in FIG. 6. The destination setting checking screen 800 includes a monitoring target device/group display area 801, a destination setting list 802, a destination input area 803, an OK button 804, and a cancel button 805.

The monitoring target device/group display area 801 displays a device or device group selected as a notification target. That is, the monitoring target device/group display area 801 displays the same contents as the device display area 603 on the notification setting creation screen 600 (FIG. 6).

The destination setting list 802 displays a list of destination settings for notification settings set in a network device configured as a notification target. For example, the destination setting list 802 displays a list of combinations of information for identifying a device, such as a device name, and destination settings set for each device. The UI control unit 301 acquires destination information from a network device, such as the printing device 104, as information related to notification settings set in the network device, and displays this information in a list such that the information can be selected. By pressing a line displaying an email address that is a destination, the corresponding email address is added to a destination input area 803, which will be described later. Furthermore, email addresses included in the destination input area 803 in the destination setting list 802 are displayed in a highlighted manner according to highlight display.

The destination input area 803 is an area in which the destination of a notification from the device or device group selected as a notification target and displayed in the monitoring target device/group display area 801 is input. Any email address can be input to the destination input area 803. Furthermore, when a line of an email address displayed in the monitoring target destination setting list 802 is pressed, the corresponding email address is added to the destination input area 803. That is, information (e.g., destinations) related to notification settings set in a network device and acquired from the network device is displayed in a list such that the information can be selected in the destination setting list 802, and information selected from the destination setting list 802 is reflected in the destination input area 803.

Once the administrator has finished input of email addresses in the destination input area 803, the administrator presses the OK button 804. Upon detecting that the OK button 804 has been pressed, the notification setting unit 321 reflects the input contents of the destination input area 803 in the destination input area 605 of the notification setting creation screen 600 (FIG. 6). That is, the information of the destination selected from the destination setting list 802 is reflected in the destination input area 803, and is reflected as the destination in the destination input area 605 of the notification being set. Further, the UI control unit 301 closes the destination setting checking screen 800 and transitions to the notification setting creation screen 600. The OK button 804 is enabled only when an email address has been input to the destination input area 803. Upon detecting that the cancel button 805 has been pressed, the notification setting unit 321 discards the input contents in the destination input area 803. The UI control unit 301 also closes the destination setting checking screen 800 and transitions to the notification setting creation screen 600.

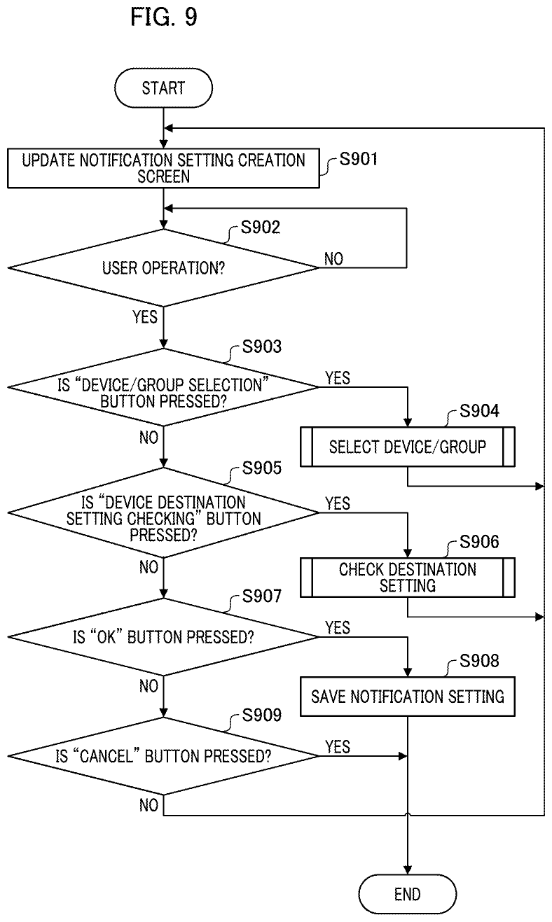

Next, notification setting processing in the present embodiment will be described using the flowcharts illustrated in FIG. 9 to FIG. 11. In the present embodiment, when setting a destination of notification from a device, the destination included in notification settings of the device is used, allowing the destination for the management device to be set while checking the destination set in the device. Processing illustrated in FIG. 9 to FIG. 11 is realized by the CPU 200 of the management device 102 executing a software program for realizing device management by the administrator through the network.

FIG. 9 is a flowchart illustrating notification setting creation processing. To create notification settings, the UI control unit 301 displays the notification setting creation screen 600 and a screen selected on the notification setting creation screen 600, and the notification setting unit 321 sets the notification settings on the basis of the settings on the notification setting creation screen 600. The administrator initiates the creation of notification settings by pressing the notification creation button 505 on the device management screen 500 (FIG. 5). The notification setting creation processing starts upon detecting that the notification creation button 505 on the device management screen 500 has been pressed. In step S901, the UI control unit 301 displays the notification setting creation screen 600. Thereafter, the UI control unit 301 performs processing of step S902.

In step S902, the UI control unit 301 receives a user operation. That is, the administrator receives an operation on the notification setting creation screen 600 using the PD 209, the KBD 206, or the like. If it is determined that a user operation has been performed, the UI control unit 301 performs processing of step S903. On the other hand, if it is determined that a user operation has not been performed, the UI control unit 301 repeats processing of step S902.

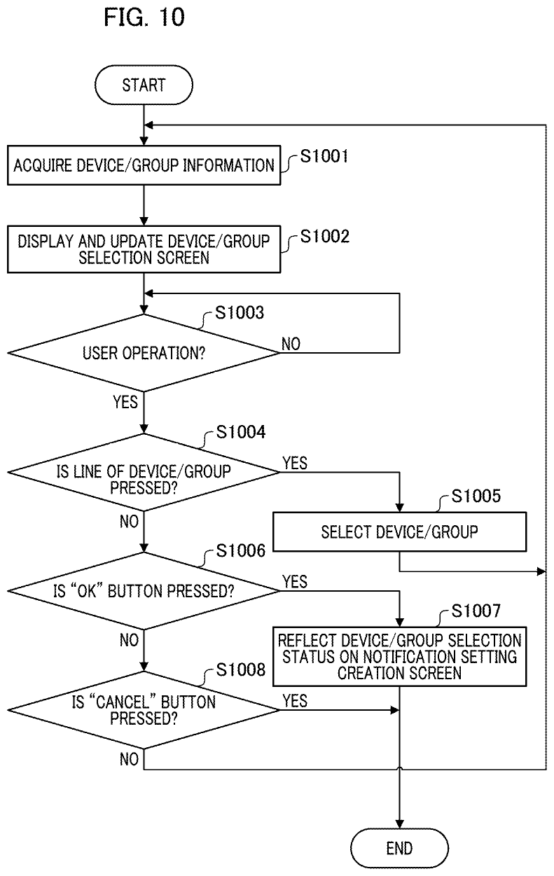

Through processing of steps S903, S905, S907, and S909, the UI control unit 301 determines the user operation on the notification setting creation screen 600 received in S902 and proceeds to processing according to the determination contents. In step S903, the UI control unit 301 determines whether the user operation received in S902 is pressing the device selection button 604. If it is determined that the user operation received in S902 is pressing the device selection button 604, the notification setting unit 321 performs processing of step S904. On the other hand, if it is determined that the user operation received in S902 is not pressing the device selection button 604, the UI control unit 301 performs processing of step S905. In step S904, a device/group that is a notification setting target is selected. Details of notification target selection processing will be described later using FIG. 10. Upon completion of processing of step S904, the UI control unit 301 performs processing of step S901.

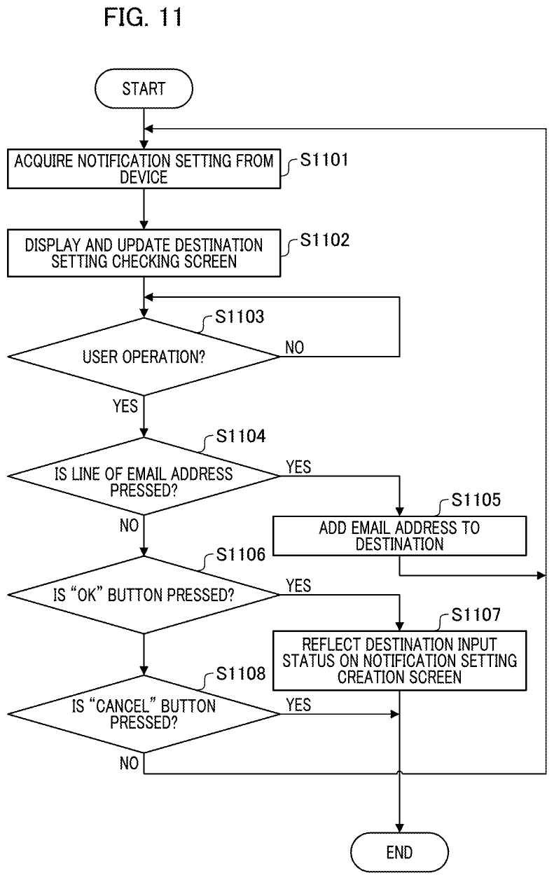

In step S905, the UI control unit 301 determines whether the user operation received in S902 is pressing the destination setting checking button 606. If it is determined that the user operation received in S902 is pressing the destination setting checking button 606, the notification setting unit 321 performs processing of step S906. On the other hand, if it is determined that the user operation received in S902 is not pressing the destination setting checking button 606, the UI control unit 301 performs processing of step S907. In step S906, the UI control unit 301 starts destination setting. Details of destination setting processing will be described later using FIG. 11. Upon completing processing of step S906, the UI control unit 301 performs processing of step S901.

In step S907, the UI control unit 301 determines whether the user operation received in S902 is pressing the OK button 608. If it is determined that the user operation received in S902 is pressing the OK button 608, the notification setting unit 321 performs processing of step S908. On the other hand, if it is determined that the user operation received in S902 is not pressing the OK button 608, the UI control unit 301 performs processing of step S909.

In step S908, the notification setting unit 321 saves the notification settings and ends the notification setting creation. That is, the notification setting unit 321 stores the input contents of the notification setting creation screen 600 in the notification setting storage unit 323. The UI control unit 301 also closes the notification setting creation screen 600. In step S909, the UI control unit 301 determines whether the user operation received in S902 is pressing the cancel button 609. If it is determined that the user operation received in S902 is pressing the cancel button 609, the notification setting unit 321 ends the notification setting creation. When ending the notification setting creation, the notification setting unit 321 discards the input contents on the notification setting creation screen 600. In addition, the UI control unit 301 closes the notification setting creation screen 600. On the other hand, if it is determined that the user operation received in S902 is not pressing the cancel button 609, the UI control unit 301 performs processing of step S901.

In step S901, which follows steps S904, S906, and S909, the UI control unit 301 updates and displays the notification setting creation screen 600. This update reflects, on notification setting creation screen, any input or selection made on the notification setting creation screen 600, the device/group selection status on the device/group selection screen 700, or input of destinations on the destination setting checking screen 800 if it is present. The UI control unit 301 also determines enablement conditions for the destination setting checking button 606 and the OK button 608, and enables or disables the destination setting checking button 606 and the OK button 608 depending on the determination result.

Next, a flow for selecting a device/group that is a notification setting target, which is executed in step S904, will be described using FIG. 10. FIG. 10 is a flowchart illustrating notification setting target selection processing. In step S1001, the notification setting unit 321 acquires device/group information from the device information storage unit 312. That is, the notification setting unit 321 acquires device information or group information of devices to be managed, stored in the device information storage unit 312.

In step S1002, the UI control unit 301 displays the device/group selection screen 700. The UI control unit 301 then performs processing of step S1003. In step S1003, the UI control unit 301 determines whether a user operation on the device/group selection screen 700 has been received. The administrator operates the device/group selection screen 700 using the PD 209, the KBD 206, or the like of the management device 102. If it is determined that a user operation on the device/group selection screen 700 has been received, the UI control unit 301 performs processing of step S1004. On the other hand, if it is determined that a user operation on the device/group selection screen 700 has not been received, the UI control unit 301 repeats the processing of step S1003.

In step S1004, the UI control unit 301 determines whether the user operation received in step S1003 is pressing a device/group line in the device/group selection area 701. If the UI control unit 301 determines that the user operation received in step S1003 is pressing a device/group line in the device/group selection area 701, the UI control unit 301 performs processing of step S1005. On the other hand, if the UI control unit 301 determines that the user operation received in step S1003 is not pressing a device/group line in the device/group selection area 701, the UI control unit 301 performs processing of step S1006.

In step S1005, the UI control unit 301 selects the device/group pressed in step S1003. That is, the UI control unit 301 holds the device or group selected by the administrator in step S1003 in a selected state. Processing then returns to step S1002.

In step S1006, the UI control unit 301 determines whether the user operation received in step S1003 is pressing the OK button 702. If it is determined that the user operation received in step S1003 is pressing the OK button 702, processing proceeds to step S1007. On the other hand, if it is determined that the user operation received in step S1003 is not pressing the OK button 702, the UI control unit 301 performs processing of step S1008.

In step S1007, the UI control unit 301 reflects the device/group selection status on the notification setting creation screen and ends destination setting checking. The UI control unit 301 reflects the selection made in the device/group selection area 701 in the monitoring target device/group display area 603 of the notification setting creation screen 600, closes the device/group selection screen 700 (FIG. 7), and transitions to the notification setting creation screen 600 (FIG. 6).

In step S1008, the UI control unit 301 determines whether the user operation received in step S1003 is pressing the cancel button 703. If it is determined that the user operation received in step S1003 is pressing the cancel button 703, the UI control unit 301 ends the device/group selection. The UI control unit 301 discards the input contents of the device/group selection screen 700, closes the device/group selection screen 700 (FIG. 7), and transitions to the notification setting creation screen 600 (FIG. 6). On the other hand, if it is determined that the user operation received in step S1003 is not pressing the cancel button 703, processing returns to step S1002.

In the processing of step S1001 after a user operation is performed on the device/group selection screen 700, the UI control unit 301 updates the display of the device/group selection screen 700. That is, in the processing of step S1001 after any of step S1005, step S1007, and step S1008 is executed, the UI control unit 301 updates the display of the device/group selection screen 700. When updating the display of the device/group selection screen 700, the UI control unit 301 reflects the selection status of the device/group on the device/group selection screen 700. The UI control unit 301 also determines the enablement condition for the OK button 702 and enables or disables the OK button 702 depending on the determination result.

Next, a destination setting checking flow executed in step S906 will be described using FIG. 11. FIG. 11 is a flowchart illustrating destination setting processing. In step S1101, the notification setting unit 321 acquires notification settings from network devices set as notification targets. The network devices set as notification targets are devices or devices in a group selected in step S904. That is, the network devices set as notification targets from which the notification settings will be acquired are devices displayed in the monitoring target device/group display area 801 and the device display area 603. The notification setting unit 321 acquires notification settings stored in the notification setting storage unit 423 from each of the devices (e.g., printing devices 104 to 106) for which notification settings are to be set via the device search unit 311 and communication unit 350.

In step S1102, the UI control unit 301 displays the destination setting checking screen 800 (FIG. 8). Upon displaying the destination setting checking screen 800, processing of step S1103 is performed. In step S1103, the UI control unit 301 determines whether a user operation on the destination setting checking screen 800 has been received. The administrator performs an operation on the destination setting checking screen 800 using the PD 209, the KBD 206, or the like. If it is determined that a user operation on the destination setting checking screen 800 has been received, the UI control unit 301 performs processing of step S1104. On the other hand, if it is determined that a user operation on the destination setting checking screen 800 has not been received, the processing of step S1103 is repeated.

In step S1104, the UI control unit 301 determines whether the user operation received in step S1103 is pressing a device/group line in the device/group selection area 701. If it is determined that the user operation received in step S1103 is pressing a device/group line in the device/group selection area 701, the UI control unit 301 performs processing of step S1105. On the other hand, if it is determined that the user operation received in step S1103 is not pressing a device/group line in the device/group selection area 701, the UI control unit 301 performs processing of step S1106. In step S1105, the UI control unit 301 adds an email address selected by the user in step S1104 to the destination input area 803. Specifically, the UI control unit 301 adds the email address which is the destination pressed by the user operation in step S1104 to the end of the destination input area 803. The UI control unit 301 then returns to the processing of step S1102.

In step S1106, the UI control unit 301 determines whether the user operation received in step S1103 is pressing the OK button 804. If it is determined that the user operation received in step S1103 is pressing the OK button 804, the UI control unit 301 performs processing of step S1107. On the other hand, if it is determined that the user operation received in step S1103 is not pressing the OK button 804, the UI control unit 301 performs processing of step S1108.

In step S1107, the UI control unit 301 reflects the email address input status on the notification setting creation screen 600 and ends the destination setting checking. That is, the UI control unit 301 reflects the input contents of the destination input area 803 in the destination input area 605 of the notification setting creation screen 600 (FIG. 6), closes the destination setting checking screen 800, and transitions to the notification setting creation screen 600.

In step S1108, the UI control unit 301 determines whether the user operation received in step S1103 is pressing the cancel button 805. If it is determined that the user operation received in step S1103 is pressing the cancel button 805, the UI control unit 301 ends notification setting creation. The UI control unit 301 discards the input contents of the destination setting checking screen 800, closes the destination setting checking screen 800, and transitions to the notification setting creation screen 600 (FIG. 6). On the other hand, if it is determined that the user operation received in step S1103 is not pressing the cancel button 805, the UI control unit 301 returns to the processing of step S1102.

In the processing of step S1101 after a user operation is performed on the destination setting checking screen 800, the UI control unit 301 updates the display of the destination setting checking screen 800. That is, the UI control unit 301 updates the display of the destination setting checking screen 800 in the processing of step S1001 after execution of any of step S1105, step S1107, and step S1108. When updating the display of the destination setting checking screen 800, the UI control unit 301 reflects the destination input contents on the destination setting checking screen 800. The UI control unit 301 also determines the enablement condition for the OK button 702 and enables or disables the OK button 804 depending on the determination result.

Note that, although the present embodiment describes an example in which destination settings are acquired from the setting target devices and displayed in step S1101, the present disclosure is not limited thereto. For example, destination settings may be acquired by designating any device or group designated by the administrator. Alternatively, destination settings may be acquired from all devices managed by the administrator. The UI control unit 301 then displays all destinations acquired in step S1101 in the device destination setting list 802 on the destination setting checking screen 800.

As described above, according to the present embodiment, at the time of setting notification settings for a device in the management device 102, the destination settings set in a network device for which notification settings are to be set can be acquired and displayed on the destination setting checking screen 800 displayed on the management device 102. This allows the administrator to input destinations for the network device notification settings while checking the destination settings already set for the printing devices 104 to 106 displayed on the destination setting checking screen 800. Furthermore, by selecting and reflecting the destinations already set for the printing devices 104 to 106 displayed on the destination setting checking screen 800 as destinations for the notification settings being set, it is possible to eliminate the need to input email addresses. This reduces the burden on the administrator in notification settings.

### Embodiment 2

In Embodiment 1, an example has been described in which the destinations included in the device notification settings can be used to set the destination for the management device while checking the destinations set for devices. In Embodiment 2, overlapping notifications to the same destination about the same status are avoided according to notification settings in the management device 102 and devices (printing devices 104 to 106). Therefore, a target status included in the notification settings of the devices is used in Embodiment 2. Note that only the differences from Embodiment 1 will be described below.

In the present embodiment, if notification settings set in the management device 102 and notification settings set in a notification target network device overlap, the overlapping network device is excluded from notification target network devices. Network devices to be excluded from the notification targets are managed in a notification setting table. Table 4 is a portion of the notification setting table in Embodiment 2. In addition to the notification setting table (Table 3) in Embodiment 1, overlapping notification avoidance setting and overlapping device setting fields are added to the notification setting table in Embodiment 2. Note that the destination, text, and enabled/disabled fields listed in Table 3 are omitted from Table 4.

TABLE 4

| | | | | Device | Overlapping | |
|---|---|---|---|---|---|---|
| Notification | Notification | | Monitoring | requiring | notification | Overlapping |
| setting ID | setting name | Status | target | notification | avoidance setting | device |
| ALART001 | Paper jam in | Paper | GRP001 | - | OFF | DEV001, |
| | building A | jam | | | | ... |
| ALART002 | No paper in | No | GRP001 | DEV001 | ON | DEV001, |
| | building A | paper | | | | ... |
| ALART101 | Paper jam in | Paper | GRP002 | - | OFF | DEV101, |
| | building B | jam | | | | ... |
| ALART102 | No paper in | No | GRP002 | - | ON | DEV101, |
| | building B | paper | | | | ... |
| ... | ... | ... | ... | ... | ... | ... |

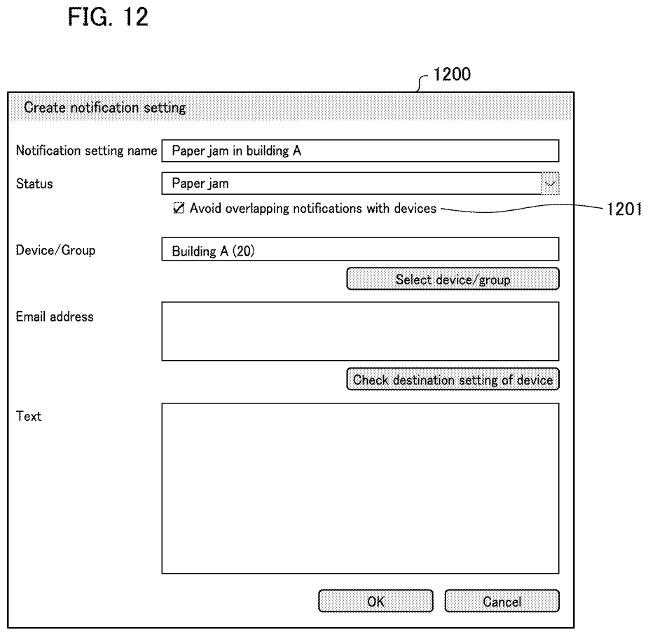

The overlapping notification avoidance setting is a setting for preventing the management device from sending overlapping notifications when a notification setting is set in a device with respect to the same status as the status of a record indicated by a notification setting ID. The overlapping notification avoidance setting field is optionally set when creating the notification setting. The method for setting the overlapping notification avoidance setting will be described later using FIG. 12. The overlapping device field holds the device IDs of devices for which notification settings are set for the same status as the status of a record indicated by the notification setting ID as a list. The overlapping device field is determined and updated by the notification unit 322 when device information is acquired, notification settings are created or changed, or a monitoring target is changed.

As described above, in the present embodiment, a list of network devices that are excluded from notification targets due to overlapping notification settings is held as overlapping devices in the notification setting table. When the overlapping notification avoidance setting is ON, network devices on the list of overlapping devices are excluded from notification target network devices. As a result, if the notification settings set in the management device 102 overlap with the notification settings set in a notification target network device, the overlapping network device can be excluded from notification target network devices.

FIG. 12 is a diagram illustrating an example of a UI of a notification setting creation screen in Embodiment 2. The notification setting creation screen 1200 is displayed on the display 207 of the management device 102 by the UI control unit 301. In addition to the display contents of the notification setting creation screen 600 in Embodiment 1, the notification setting creation screen 1200 displays an overlapping notification avoidance setting area 1201. The overlapping notification avoidance setting area 1201 is an option for receiving the selection of whether to perform overlapping notifications when the set notification settings overlap with the notification settings set in the notification target network device. The overlapping notification avoidance setting area 1201 allows settings to be switched ON/OFF, for example, in the form of a checkbox. When the notification setting unit 321 detects pressing of the OK button 608 and saves the setting notification (S908), the notification setting unit 321 reflects the settings in the overlapping notification avoidance setting area 1201 in the overlapping notification avoidance setting in the notification setting table (Table 4). If the checkbox in the overlapping notification avoidance setting area 1201 is checked, the overlapping notification avoidance setting in the notification setting table (Table 4) is turned ON. On the other hand, if the checkbox in the overlapping notification avoidance setting area 1201 is not checked, the overlapping notification avoidance setting in the notification setting table (Table 4) is turned OFF. For example, the administrator turns OFF the overlapping notification avoidance setting if they want to send notifications to different administrators, if they want to receive and aggregate notifications separately from both the network device and the application on the management device 102, or if they want to receive notifications from different mail servers. Furthermore, the notification setting unit 321 stores information about devices for which the notification status created on the notification setting creation screen 600 and the notification status set in the device overlap in the overlapping device field of the notification setting table (Table 4). Note that, although an example in which overlap is determined based only on whether the notification setting status matches is described in the present embodiment, overlap determination may also be performed based on the AND condition of whether the notification setting status matches with the destination.

Note that, although an example of a case in which notifications from the application on the management device 102 are suppressed to avoid overlapping notification settings has been described in the present embodiment, the present disclosure is not limited thereto. For example, to avoid overlapping notification settings, a network device may be instructed to suppress notifications from the network device itself rather than from the management device 102. This allows overlapping notifications to be consolidated into notifications from the application on the management device 102. Furthermore, although a list of devices to be excluded from notifications is created in the overlapping device field of the notification setting table (Table 4) to avoid overlapping notification settings in the present embodiment, the present disclosure is not limited thereto. For example, overlapping notifications may be avoided by creating a new device group that excludes network devices with overlapping notifications and creating new notification settings for the group.

As described above, the present embodiment allows the administrator to perform settings to prevent overlapping notifications for the same status without checking the notification settings of each device. This prevents overlapping notifications and reduces the burden on the administrator in notification settings.

### Embodiment 3

In Embodiment 1, destinations included in notification settings of devices are used to reduce the burden on the administrator in notification settings. In addition, in Embodiment 2, the target status included in the notification settings of the device is used to reduce the burden on the administrator in notification settings. In Embodiment 3, information on text of a notification included in the notification settings of the device is used to reduce the burden on the administrator in notification settings. Therefore, in the present embodiment, a method that enables checking of text setting of a device in a manner similar to checking of destination setting of the device in Embodiment 1 is described. Note that only the differences from Embodiments 1 and 2 are described below.

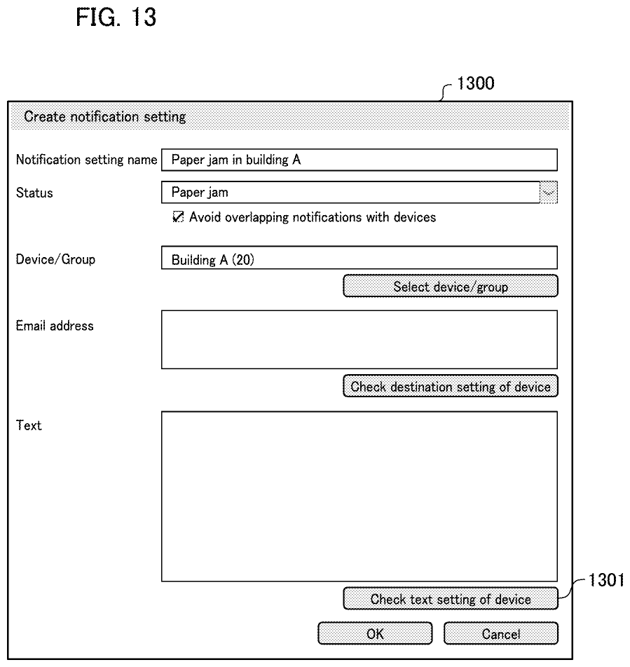

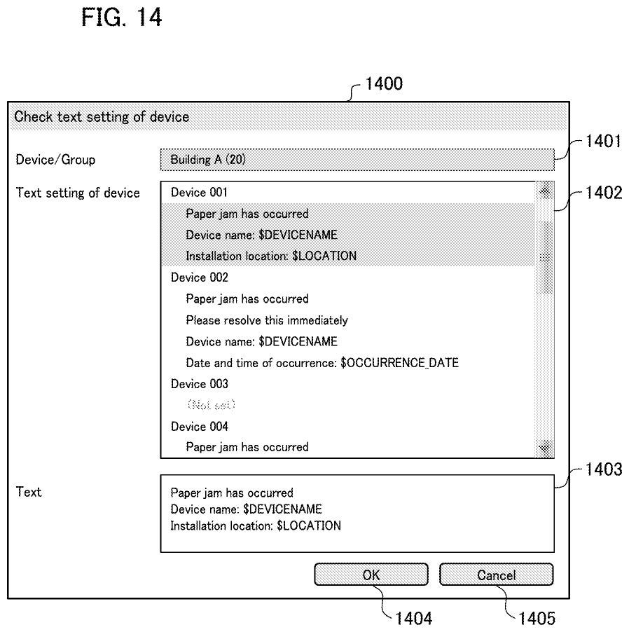

FIG. 13 is a diagram illustrating an example of a UI of a notification setting creation screen in Embodiment 3. The notification setting creation screen 1300 is displayed on the display 207 of the management device 102 by the UI control unit 301. In addition to the display contents of the notification setting creation screen 1200 in Embodiment 2, the notification setting creation screen 1300 also displays a device text setting checking button 1301. The administrator presses the device text setting checking button 1301 to check the text of notification already set in a device. Note that the device text setting checking button 1301 is enabled only when a device or group is selected. Upon detecting that the device text setting checking button 1301 has been pressed, the UI control unit 301 displays a text setting checking screen 1400 (FIG. 14).

FIG. 14 is a diagram illustrating an example of a UI of the text setting checking screen 1400 in Embodiment 3. The text setting checking screen 1400 is displayed on the display 207 of the management device 102 by the UI control unit 301. The text setting checking screen 1400 is displayed when the administrator presses the device text setting checking button 1301 on the notification setting creation screen 1300. The text setting checking screen 1400 is similar to the destination setting checking screen 800 in Embodiment 1, with the destination replaced with the text.

The text setting checking screen 1400 displays a monitoring target device/group display area 1401, a device text setting list 1402, a text input area 1403, an OK button 1404, and a cancel button 1405. The monitoring target device/group display area 1401 displays a device or device group selected as a notification target. That is, the monitoring target device/group display area 1401 displays the same content as the monitoring target device/group display area on the notification setting creation screen 1300.

The device text setting list 1402 lists text of notifications set for a notification setting sun device. The device text setting list 1402 displays a list of notification text already set for the device or group of devices displayed in the monitoring target device/group display area 1401. When a line displaying email text is pressed in the device text setting list 1402, the UI control unit 301 adds the corresponding text to the text input area 1403. The UI control unit 301 also highlights and displays the email text included in the text input area 1403, i.e., the text selected by the administrator in the device text setting list 1402 using highlight display. Note that, although an example in which the device text setting list 1402 displays only text of notification set for the network device is described in the present embodiment, templates prepared by the application of the management device 102 may also be displayed in addition thereto.

In the text input area 1403, text (email text) to be notified through the notification setting being set is set. Text can be set in the text input area 1403 by direct input or by selection from the text setting list 1402. Therefore, the administrator can input any email text in the text input area 1403. When the administrator presses a line of email text displayed in the text setting list 1402 of the monitoring target, the corresponding email text is added to the text input area 1403.

Upon detecting that the OK button 1404 has been pressed by the administrator, the UI control unit 301 reflects the input contents in the text input area 1403 in the text input area of the notification setting creation screen 1300 (FIG. 13). The UI control unit 301 then closes the text setting checking screen 1400 and transitions to the notification setting creation screen 1300. Note that the OK button 1404 is enabled only when email text has already been input to the text input area 1403. Upon detecting that the cancel button 1405 has been pressed by the administrator, the UI control unit 301 discards the input contents in the text input area 1403, closes the text setting checking screen 1400, and transitions to the notification setting creation screen 1300.

In the notification setting processing (FIG. 9), the UI control unit 301 performs text setting processing upon detecting that the device text setting checking button 1301 has been pressed. Processing of detecting pressing of the device text setting checking button 1301 is executed, for example, between steps S905 and S907. In text setting processing, the UI control unit 301 displays the text setting checking screen 1400. Text settings acquired from a device selected as a notification setting target are displayed in the device text setting list 1402 on the text setting checking screen 1400. The administrator can set text for notification settings being set while checking text settings acquired from the device. Note that, although an example in which text settings are acquired from a device selected as a notification setting target and displayed is described in the present embodiment, the present disclosure is not limited thereto. For example, text settings may be acquired and displayed by designating an arbitrary device or group, or text settings may be acquired and displayed from all devices managed by the administrator.

As described above, according to the present embodiment, when performing notification settings for devices in the management device 102, text of notifications set for notification setting target network devices can be acquired and displayed on the text setting checking screen 1400 displayed on the management device 102. This allows the administrator to set text of notification settings for network devices while checking text already set for the printing devices 104 to 106 displayed on the text setting checking screen 1400. Furthermore, by selecting and reflecting the text already set for the printing devices 104 to 106 displayed on the text setting checking screen 1400 as text for the notification settings being set, the effort of inputting text can be reduced. This reduces the burden on the administrator in notification settings.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-070288, filed Apr. 22 2025, which is hereby incorporated by reference wherein in its entirety.

What is claimed is:

1. A non-transitory storage medium storing instructions that, when executed by a processor of an information processing device managing network devices, cause the processor to:
display a screen for setting notification of information related to a network device by the network device; and
set a notification setting on the basis of settings on the screen,
wherein the screen displays information related to a notification setting set in the network device, acquired from the network device.

2. The non-transitory storage medium according to claim 1, wherein the information related to the notification setting set in the network device, acquired from the network device, is displayed in a list such that the information is selectable, and information selected from the list is reflected in a notification being set.

3. The non-transitory storage medium according to claim 1, wherein the information related to the notification setting set in the network device, displayed on the screen, is information indicating a notification destination or text included in notification.

4. The non-transitory storage medium according to claim 1, wherein the instructions further cause the processor to receive a status of a notification target network device and settings of the notification target network device through a notification setting creation screen displayed as the screen for setting notifications, acquire information on destinations of the notification setting set in the network device from the network device set as a notification target in response to selection of a button for checking destinations displayed on the creation screen, and display a list of the destinations acquired from the notification target network device.

5. The non-transitory storage medium according to claim 1, wherein the instructions further cause the processor to receive a status of a notification target network device and settings of the notification target network device through a notification setting creation screen displayed as the screen for setting notifications, acquire information on notification text of the notification setting set in the network device from the network device set as a notification target in response to selection of a button for checking the notification text displayed on the creation screen, and display a list of the notification text acquired from the notification target network device.

6. The non-transitory storage medium according to claim 1, wherein when setting the notification setting, in a case in which the notification setting overlaps with a notification setting set in a notification target network device, the instructions further cause the processor to exclude a network device having the overlapping notification setting from notification target network devices in the notification setting to be set.

7. The non-transitory storage medium according to claim 6, wherein when setting the notification setting, the instructions further cause the processor to save a notification setting table based on the settings on the screen, and the notification setting table holds a list of network devices excluded from the notification targets due to the overlapping notification setting.

8. The non-transitory storage medium according to claim 6, wherein the notification setting creation screen displayed in a process of displaying the screen displays an option for receiving a selection of whether to perform the overlapping notification when the notification being set on the creation screen overlaps with the notification setting set in the notification target network device,
wherein, in the setting of the notification setting, notification setting is performed according to a selection of whether to perform the overlapping notification.

9. An information processing device managing network devices, comprising:
a memory storing instructions; and
a processor executing the instructions causing the information processing device to:
control display of a screen for setting notification of information related to a network device by the network device; and
set a notification setting on the basis of settings on the screen,
wherein the screen displays information related to a notification setting set in the network device, acquired from the network device.

10. A method for controlling an information processing device managing network devices, the method comprising:
displaying a screen for performing settings related to notification by a network device; and
setting a notification setting on the basis of settings on the screen,
wherein the screen displays information related to a notification setting set in the network device, acquired from the network device.
